(19) United States
(12) Patent Application Publication
(10) Pub. No.: US 2015/0168740 A1
(43) Pub. Date: Jun. 18, 2015

(54) INTERCHANGEABLE FRAMES

(71) Applicant: Kathleen Barnes, Ocean View, DE (US)

(72) Inventor: Kathleen Barnes, Ocean View, DE (US)

(21) Appl. No.: 13/745,935

(22) Filed: Jan. 21, 2013

(51) Int. Cl. G02C 5/00; A47F 7/02; G02C 13/00

(52) U.S. Cl. CPC G02C 5/001; G02C 13/001; G02C 5/008; A47F 7/021

(57) ABSTRACT

An eyewear system comprising [1] at least one lens and [2] a plurality of interchangeable frames for support of the lenses, wherein each of the frames is adapted for removable connection to said at least one lens; and a system for storing/displaying the frames and lenses.

### FIELD OF THE INVENTION

This invention relates to eyewear, and more particularly relates to eyewear having interchangeable decorative frames which can be easily removed and exchanged.

### BACKGROUND OF THE INVENTION

There are a variety of eyewear now made with attractive frames. Many who wear this eyewear are often very fashion conscious and would find different designs desirable for different purposes, and a wide variety of circumstances. However, owning and carrying a number of pairs of this eyewear is not practical. Therefore, it would be advantageous if a single eyewear lens system could be attractively decorated to provide a wide variety of designs.

There are sunglasses known that have a frame and nosepiece construction that permits them to be removed and replaced as well as allowing pane replacement. These glasses are disclosed and described in U.S. Pat. No. 4,674,851, issued Jun. 23, 1987. In these glasses, however, the frame and temples remain the same but the pane, lens and nosepiece can be removed and replaced. They do not permit or describe any type of interchangeable decorative frame.

It is therefore an object of the present invention to provide eyewear that can be changed to provide a wide variety of designs.

Yet another object of the present invention is to provide eyewear that can be selectively changed to provide a different appearing frame.

Still another object of the present invention is to provide eyewear having interchangeable decorative frames that can be easily removed and exchanged.

### BRIEF DESCRIPTION OF THE INVENTION

One embodiment of the invention relates to an eyewear system comprising [1] at least one lens and [2] a plurality of interchangeable frames for supporting said at least one lens, wherein each of the frames is adapted for removable connection to said at least one lens.

An additional embodiment of the invention concerns a system for storing and/or displaying the above-described eyeglass lenses and plural interchangeable frames therefore.

### BRIEF DESCRIPTION OF THE DRAWING

FIG. 1 is an isometric view of one embodiment of the inventive eyeglasses.

FIG. 2 is a partial cross-sectional view taken along the line 2-2 of FIG. 1.

FIGS. 3-6 are schematic views showing various techniques for installing lenses in frames of the eyeglasses shown in FIG. 1.

FIG. 7 is a perspective view of an eyeglass frame and lens holder display/storage system according to a preferred embodiment of the invention

### DETAILED DESCRIPTION OF THE INVENTION

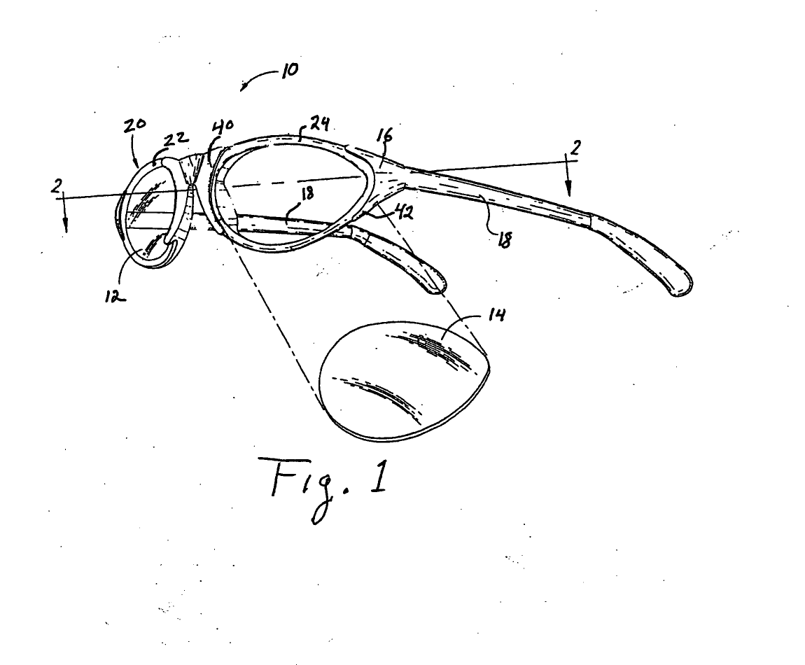

One embodiment of the invention is shown in FIG. 1. The spectacles are embodied in eyeglasses 10 having lenses 12, 14 mounted in a frame, generally indicated at 20. The frame 20 includes an attachment area 16. A pair of temples 18 is pivotally secured to frame 20 in a conventional manner. However, other securing devices, such as straps extending behind the head of the wearer, may be used.

The lens 12 is shown installed in the right frame section 22, and the lens 14 is shown removed from the left frame section 24. As is most apparent in the drawing of the left frame section 24 without the lens 14, the frame section 24 includes an inner lens attachment clip 40 and an outer lens attachment clip 42.

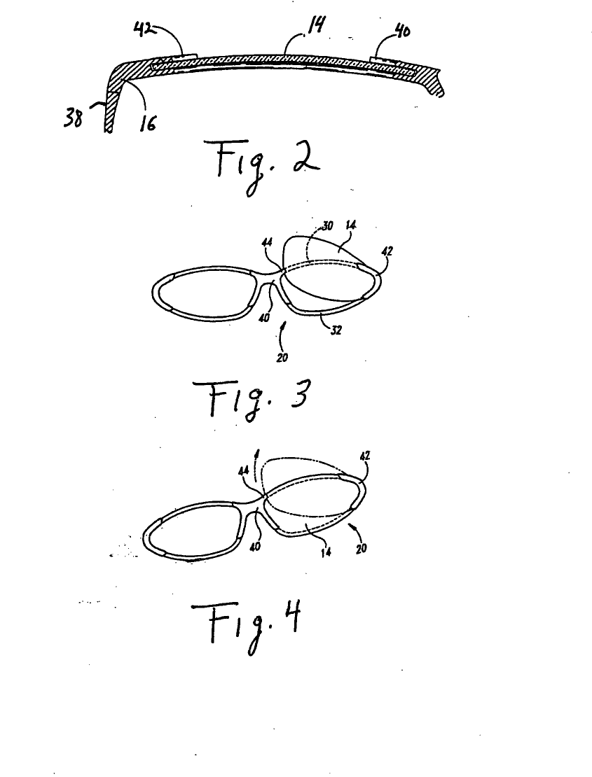

With reference also to the cross-sectional view of FIG. 2, the clips 40, 42 are spaced from the forward surface of the frame 20. The spacing between the clips 40, 42 and the frame 20 is preferably slightly less than the thickness of the lens 14. Since the frame 20 is preferably formed from a resilient material, such as resilient plastic, the lens resiliently deforms the clips 40, 42 and/or frame 20 to securely hold the lens 14 in position.

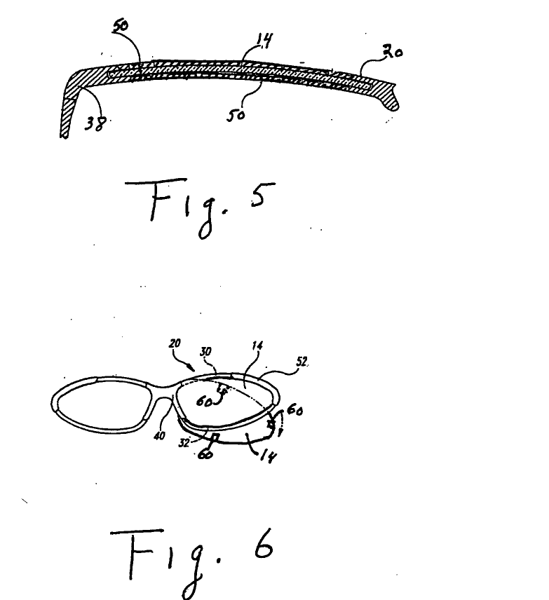

A variety of techniques can be used to remove the lenses 12, 14 from the frame 20, with the optimum technique depending upon the specific frame and lens structures and the preference of the user. As illustrated in FIG. 3, the lens 14 can be installed from the top 30 of the frame 20 by placing the outer edge of the lens 14 beneath the outer lens attachment clip 42 and the lower inner edge of the lens 14 beneath the inner lens attachment clip 40. The user then exerts a force on the upper edge of the lens 14 in a downward direction (i.e., toward the lower part 32 of frame 20), thereby forcing the remainder of the inner edge of the lens 14 beneath the inner lens attachment clip 40. As shown in FIG. 4, the force is preferably applied to the edge of the lens 14 at a location that is closer to the inner lens attachment clip 40 than it is to the outer lens attachment clip 42.

The lens 14 can be removed from the frame 20 as shown in FIG. 4. The user applies a force to the lower edge of the lens 14 adjacent the inner lens attachment clip 40. Because of the resilient nature of the frame 20 and/or lens 14, the lens 14 slides out from underneath the lens attachment clip 40, thereby removing the lens 14 from the frame 20. After removal of the lens 14, another frame having a different appearance may have the lenses 12 and 14 installed therein as shown in FIG. 3.

It should be reemphasized that the installation and removal techniques shown in FIGS. 3-4 are illustrative only and other techniques may therefore be used depending upon the specific lens and frame structure of the eyeglasses. Also, although specific eyewear styles are shown in FIGS. 1-4, it will be understood that other eyewear styles may be devised without departing from the invention.

Moreover, without departing from the spirit and scope of the invention and the claims contained herein, other variations for affixing the lenses in the interchangeable frames may be employed. For example, as shown in FIG. 5, interchangeable frames 20 may be provided with a slot 50 in the top of the frame, into which the lens 14 may be dropped.

As depicted in FIG. 6, the lens 14 may be fitted with magnetic strips 60 which function to attach to metal strip(s) (not shown) on the back side of frame 20. Alternatively, the strips 60 may be metallic and attach to the strip(s) on the back of the frame 20, which is magnetized.

It will be understood by those skilled in the art that the invention is not limited to any specific type of eyeglass lens or interchangeable frame therefore; nor is the invention limited to a specific color or decorative pattern on either the lenses or frames. Finally, the invention is not limited to any convenient means for securing the lenses in the frames when interchanging the latter.

Typically, at least one of the lenses comprises an oculus sinister lens and the other, an oculus dexter lens. In addition, at least one of the lenses is corrective. The lenses may be tinted, polarized or otherwise structured so as to achieve a particular optical effect. The lenses may be constructed of any suitable optical material such as, for example, glass or polycarbonate. The lenses may be bi- or tri-focal; i.e., each lens includes first and second, and optionally, third lens portions wherein each portion is separately corrective.

The interchangeable frames may be constructed of any convenient material suitable for the purpose, such as, e.g., plastic or metal.

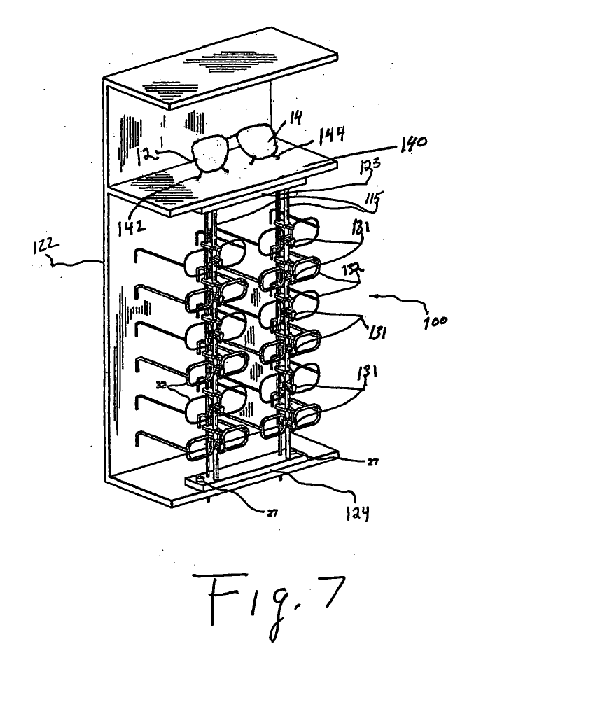

Another embodiment of the invention is illustrated in FIG. 7 which is an eyeglass frame and lens holder display system. The eyeglass frame and lens holder 100 comprises two vertical posts 115 mounted on a cabinet 122 so as to form a display. It will be understood by those skilled in the art that the eyeglass frame holder 100 could comprise only one post or more than two posts. As a matter of fact, it could comprise an unlimited number of posts. In all cases, the posts are preferably rigidly attached to a pair of support members 123 and 124. The eyeglass frame and lens holder 100 also comprises a plurality of supporting members 131 for supporting a corresponding number of eyeglass frames 132. Each supporting member 131 is connected to the adjacent vertical post 115 so as to project horizontally from it. Each supporting member 131 is also shaped and sized to fit into and support an eyeglass frame 132. Cabinet 122 is preferably provided with an upper portion 140, in which one or more pair of lenses 12,14 may be displayed or stored; for example on racks 142 and 144. Each such pair of lenses is, of course, susceptible of attachment to anyone of the interchangeable frames 132.

Other variations will be apparent to one of ordinary skill in the art.

From the foregoing, it will therefore be evident that, although specific embodiments of the invention have been described herein for purposes of illustration, various modifications may be made without departing from the spirit and scope of the invention and the claims contained herein.

I claim:

1. An eyewear system comprising [1] at least one lens and [2] a plurality of interchangeable frames for supporting said at least one lens, wherein each of said frames is adapted for removable connection to said at least one lens.

2. The eyewear system of claim 1 wherein said at least one lens comprises an oculus sinister lens and an oculus dexter lens.

3. The eyewear system of claim 1 wherein said frames are each decoratively different.

4. The eyewear system of claim 1 wherein said at least one lens is corrective.

5. The eyewear system of claim 1 wherein said at least one lens is tinted.

6. The eyewear system of claim 1 wherein said at least one lens comprises polycarbonate.

7. The eyewear system of claim 1 wherein each of said at least one lens includes a first and second lens portions.

8. The eyewear system of claim 6 wherein said first and second lens portions are corrective.

9. The eyewear system of claim 1 wherein said at least one lens is made of an optical material.

10. The eyewear system of claim 1 wherein each of said frames is adapted for removable snap-fit connection to said at least one lens.

11. The eyewear system of claim 1 wherein each of said frames is adapted for removable connection to said at least one lens by magnetic means.

12. The eyewear system of claim 1 wherein each of said frames is plastic.

13. The eyewear system of claim 1 wherein each of said frames is metallic.

14. A system for storing and/or displaying eyeglass lenses and plural spectacle frames therefore comprising a framework adapted to releasably and separately secure plural frames, each mutually interchangeable to house said eyeglass frames and, in communication with said framework, means for releasably holding said eyeglass frames.

15. The system of claim substantially as depicted in FIG. 7.
